(19) United States
(12) Patent Application Publication
(10) Pub. No.: US 2011/0281183 A1
(43) Pub. Date: Nov. 17, 2011

(54) FUEL CELL

(75) Inventors: Ryuhei Matsumoto, Kanagawa (JP); Taiki Sugiyama, Kanagawa (JP); Hideyuki Kumita, Kanagawa (JP); Hideki Sakai, Kanagawa (JP)

(73) Assignee: SONY CORPORATION, Tokyo (JP)

(21) Appl. No.: 13/085,719

(22) Filed: Apr. 13, 2011

(30) Foreign Application Priority Data
May 12, 2010 (JP) 2010-109829

(51) Int. Cl. H01M 8/16

(52) U.S. Cl. 429/401

(57) ABSTRACT

A fuel cell includes: one or a plurality of cell sections having an electrode with an oxidoreductase present at a surface thereof; and a container in which the cell section or sections are contained; wherein the container is provided with a fuel solution pouring port through which to pour a fuel solution into the cell section or sections, and the fuel solution pouring port is oriented in a fixed direction at least at the time of pouring the fuel solution.

### BACKGROUND OF THE INVENTION

1. Field of the Invention

The present invention relates to a biofuel cell in which an oxidoreductase is used. Particularly, the invention relates to a technology for enhancing handleability of a biofuel cell.

2. Description of the Related Art

Biofuel cells in which an oxidoreductase is used as a reaction catalyst are advantageous in that electrons can be efficiently taken out from a fuel which cannot be utilized with ordinary industrial catalysts, such as glucose and ethanol. In view of this, the biofuel cells are expected as next-generation fuel cells high in capacity and safety. FIG. 5 shows a reaction scheme of a biofuel cell in which an enzyme is used. For example, in the case of a biofuel cell using glucose as a fuel, as shown in FIG. 5, an oxidation reaction of glucose proceeds and electrons are taken out at a negative electrode (anode), whereas a reduction reaction of oxygen (O₂) in air proceeds at a positive electrode (cathode).

Meanwhile, in primary cells and secondary cells which are in general use at present, power generation or charging is conducted by using only active materials disposed in the inside thereof. Such primary and secondary cells, therefore, are not provided with a mechanism for pouring a fuel thereinto, and do not need such a mechanism. On the other hand, a fuel cell is a device designed to generate electric power by externally pouring a fuel into the inside thereof. Therefore, the fuel cell needs a fuel supply mechanism, and the inside of the cell is spatially connected to the exterior.

In addition, a fuel cell is capable of serving for power generation repeatedly, by replenishing a fuel solution. In biofuel cells according to the related art, also, a casing is provided with a fuel solution pouring port (see, for example, Japanese Patent Laid-Open No. 2008-282586 and Japanese Patent Laid-Open No. 2009-048848 (hereinafter referred to as Patent Documents 1 and 2, respectively)). For instance, Patent Document 1 proposes button-type and tubular cells in which a metallic casing is used, while Patent Document 2 proposes a cubic cell in which a plastic-made casing is used, and, in both cases, a fuel solution pouring port is provided at an upper surface of the casing.

### SUMMARY OF THE INVENTION

However, the above-mentioned biofuel cells according to the related art may be disadvantageous in that the position of the fuel solution pouring port is difficult to grasp. In such a situation, there is a possibility of misuse, such as erroneous pouring of a fuel solution. The risk of misuse is particularly high in the case where the fuel cell is used by a child or a visually handicapped person.

Thus, there is a need for a fuel cell of which misuse is unlikely to occur.

According to an embodiment of the present invention, there is provided a fuel cell including: one or a plurality of cell sections having an electrode with an oxidoreductase present at a surface thereof; and a container in which the cell section or sections are contained; wherein the container is provided with a fuel solution pouring port through which to pour a fuel solution into the cell section or sections, and the fuel solution pouring port is oriented in a fixed direction at least at the time of pouring the fuel solution.

Here, the surface of the electrode includes wholly the outer surfaces of the electrode and the inner surfaces of voids in the inside of the electrode. This applies hereinafter.

In this fuel cell, the fuel solution pouring port is oriented in a fixed direction, which permits even a child or a visually handicapped person to easily recognize the position of the fuel solution pouring port.

As a result, misuse of the fuel cell at the time of pouring a fuel solution into the cell can be prevented.

In the fuel cell, a bottom portion of the container may have a curved surface.

In this case, desirably, the center of gravity of the fuel cell is set below the center of the fuel cell.

In the fuel cell, a magnet may be attached to a bottom portion of the container so that the fuel cell is positioned by a magnetic force.

Further, a configuration may be adopted in which the fuel cell has a mount on which to mount the container, and a magnet is attached at least to a container-mounting portion of the mount so that the fuel cell is positioned by a magnetic force.

Furthermore, the fuel solution pouring port may be provided with a valve operative to prevent leakage of the fuel solution at least.

According to the embodiment of the present invention, the fuel solution pouring port of the fuel cell is oriented in a fixed direction. Therefore, it is easy even for a child or a visually handicapped person to recognize the position of the fuel solution pouring port; accordingly, misuse of the fuel cell can be prevented from occurring.

### BRIEF DESCRIPTION OF THE DRAWINGS

FIG. 1A is a side view showing schematically the outer shape of a biofuel cell according to a first embodiment of the present invention, and FIG. 1B is a plan view of the same;

FIGS. 2A and 2B each schematically illustrate a method of sealing off a fuel solution pouring port after the pouring of a fuel solution;

FIG. 3 is a conceptual illustration of another method for preventing accidental drinking (or swallowing) of a fuel solution or the like;

FIG. 4 is a sectional view showing schematically the structure of a biofuel cell according to a second embodiment of the present invention; and

FIG. 5 is a diagram showing a reaction scheme of a biofuel cell in which an enzyme is used.

### DETAILED DESCRIPTION OF THE PREFERRED EMBODIMENTS

Now, some embodiments of the present invention will be described in detail below, referring to the accompanying drawings. Incidentally, the invention is not to be limited to the following embodiments. The description will be made in the following order.

1. First Embodiment
(an example of biofuel cell of which a bottom surface has a curved surface)

2. Second Embodiment
(an example of biofuel cell with a magnet attached to a bottom surface thereof)

### 1. First Embodiment

### [General Configuration]

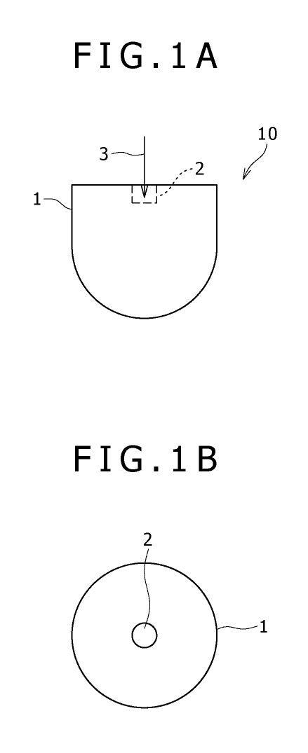

First, a biofuel cell according to a first embodiment of the present invention will be described. FIG. 1A is a side view showing schematically the outer shape of the biofuel cell in this embodiment, and FIG. 1B is a plan view of the same. In the biofuel cell 10 according to this embodiment, one or a plurality of cell sections having electrodes with an oxidoreductase present at surfaces thereof are contained in a container 1. In addition, as shown in FIGS. 1A and 1B, the container 1 has a bottom surface composed of a curved surface, and is provided, for example at an upper surface thereof, with a fuel solution pouring port 2 through which to pour a fuel solution 3 into the cell section(s).

### [Cell Section]

The cell section may, for example, have a configuration in which an anode and a cathode are disposed opposite to each other, with a protonic conductor therebetween. As the anode, there can be used, for example, an electrode formed from a conductive porous material with an oxidoreductase immobilized on the surface thereof. As the cathode, there can be used, for example, an electrode formed from a conductive porous material with an oxidoreductase and an electron mediator immobilized on the surface thereof. Here, the surface of the electrode includes wholly the outer surfaces of the electrode and the inner surfaces of voids present inside the electrode. The same applies hereinafter.

In this configuration, at the anode, a fuel is decomposed by the enzyme immobilized on the anode surface, electrons are taken out, and protons (H⁺) are generated. At the cathode, on the other hand, water is produced from the protons transported from the anode through the protonic conductor, the electrons sent from the anode through an external circuit, and oxygen supplied from air, for example.

In addition, as the conductive porous material for forming the anode, known materials can be used. Particularly preferred are carbon materials, such as porous carbon, carbon pellet, carbon felt, carbon paper, laminate of carbon fibers or carbon particulates, etc. Further, as the enzyme immobilized on the surface of the anode, for example in the case where the fuel is glucose, there can be used glucose dehydrogenase (GDH) by which glucose is decomposed.

Furthermore, in the case where a monosaccharide such as glucose is used as the fuel, a coenzyme oxidase and/or an electron mediator is desirably immobilized on the anode surface, in addition to the oxidase which accelerates oxidation of the monosaccharide such as GDH to thereby decompose the monosaccharide. The coenzyme oxidase is for oxidizing a coenzyme which is reduced by an oxidase (for example, NAD⁺, NADP⁺, etc.) and a reduced coenzyme (for example, NADH, NADPH, etc.). Examples of the coenzyme oxidase include diaphorase. When the coenzyme is returned to the oxidized form under the action of the coenzyme oxidase, electrons are produced. The electrodes thus produced are transferred from the coenzyme oxidase to the electrode through the electron mediator.

As the electron mediator, there is preferably used a compound having a quinone skeleton, particularly, a compound having a naphthoquinone skeleton. Specific examples of such a compound include 2-amino-1,4-naphthoquinone (ANQ), 2-amino-3-methyl-1,4-naphthoquinone (AMNQ), 2-methyl-1,4-naphthoquinone (VK3), and 2-amino-3-carboxy-1,4-naphthoquinone (ACNQ). As the compound having the quinone skeleton, not only the compounds having the naphthoquinone skeleton but also anthraquinone and its derivatives can be used, for example. Further, if necessary, together with the compound having the quinone skeleton, one or more other compounds which act as electron mediator may be immobilized on the anode surface.

In the case where a polysaccharide is used as the fuel, a breakdown enzyme capable of accelerating decomposition (e.g., hydrolysis) of the polysaccharide to produce a monosaccharide such as glucose is desirably immobilized on the anode surface, in addition to the above-mentioned oxidase, coenzyme oxidase, coenzyme and electron mediator. Incidentally, the term “polysaccharides” here is used in a wide meaning, namely, is used to mean all the carbohydrates capable of producing two or more monosaccharide molecules through hydrolysis, and it include oligosaccharides such as disaccharides, trisaccharides, tetrasaccharides, etc. Specific examples of the polysasccharide include starch, amylose, amylopectin, glycogen, cellulose, maltose, sucrose, and lactose. These have two or more monosaccharides bonded to each other. Every one of the polysaccharides contain glucose as the monosaccharide serving as bonding units.

Besides, amylose and amylopectin are components contained in starch; in other words, starch is a mixture of amylose and amylopectin. For example, in the case where glucoamylase is used as a breakdown enzyme for polysaccharides and where glucose dehydrogenase is used as an oxidase for monosaccharides, polysaccharides capable of being decomposed to glucose by glucoamylase can be used as fuel. Examples of such polysaccharides include starch, amylose, amylopectin, glycogen, and maltose. Here, glucoamylase is a breakdown enzyme for hydrolyzing α-glucan such as starch to produce glucose, and glucose dehydrogenase is an oxidase for oxidizing β-D-glucose to D-glucono-δ-lactone.

On the other hand, as the conductive porous material for forming the cathode, also, known materials can be used, of which particularly preferred are carbon materials such as porous carbon, carbon pellet, carbon felt, carbon paper, laminate of carbon fibers or carbon particulates, etc. Examples of the oxygen reductase to be immobilized on the cathode include bilirubin oxidase, laccase, and ascorbate oxidase. Besides, examples of the electron mediator to be immobilized together with the enzyme include potassium hexacyanoferrate, potassium ferricyanide, and potassium octacyanotungstate.

Further, the protonic conductor may be any material which does not have electronic conductivity and which is capable of transporting protons (H⁺). Examples of such a material include cellophane, gelatin, and ion exchange resins having a fluorine-containing carbonsulfonate group. Besides, electrolytes can also be used as the protonic conductor.

Incidentally, the electrodes provided in the cell section are not limited to those having the oxidoreductase immobilized on the surface thereof, insofar as the oxidoreductase is present at the electrode surface. Specifically, electrodes such that microorganism having an oxidoreductase is deposited on the surface thereof and such that the above-mentioned actions are realized at the anode and the cathode can also be used.

### [Container 1, Fuel Solution Pouring Port 2]

It suffices for the container 1 to have a structure wherein the bottom surface is a curved surface and the internal volume is sufficient for containing the cell section(s). Besides, the material of the container 1 is not particularly limited. From the viewpoint of the casing of the fuel cell, however, the container 1 is desirably formed from a material which is impermeable to water and is rigid. Examples of such a material include polyethylene, polypropylene, and polyethylene terephthalate.

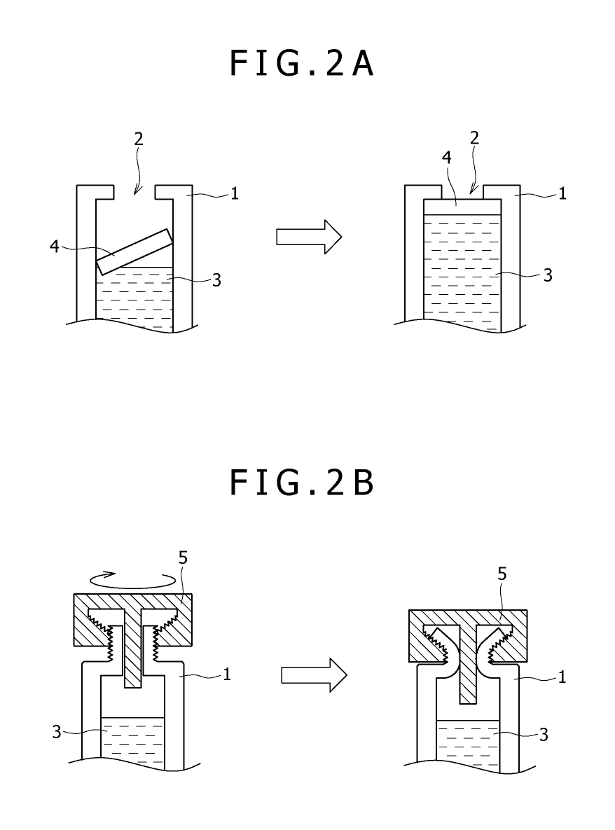

In addition, in the biofuel cell 10 according to this embodiment, the bottom surface of the container 1 is composed of a curved surface so that the fuel solution pouring port 2 is oriented in a fixed direction. In this case, desirably, the cell section(s) and the like are so disposed that the center of gravity of the biofuel cell 10 is located below the center of the biofuel cell 10. As a result, stability of the biofuel cell 10 is enhanced, and the fuel solution pouring port 2 is oriented in a fixed direction (in the case of FIG. 2, the upward direction) unless an external force is exerted on the biofuel cell 10. Further, even where an external force is exerted on the biofuel cell 10, the fuel solution pouring port 2 returns to its original position (in the case of FIG. 2, the fuel solution pouring port 2 is oriented upward) upon removal of the load (external force).

On the other hand, in the case of a container which is circular in plan view as shown in FIG. 1B, the fuel solution pouring port 2 is desirably provided at the upper surface. However, for example in the case of a container which is polygonal in plan view, the fuel solution pouring port 2 may be provided at a side surface. In addition, the fuel solution pouring port 2 is desirably provided with a check valve for preventing reverse flow of the fuel solution 3 poured into the cell. As a result, even in the case where the container is laid down, leakage of the fuel solution 3 is prevented, so that a safer fuel cell can be realized.

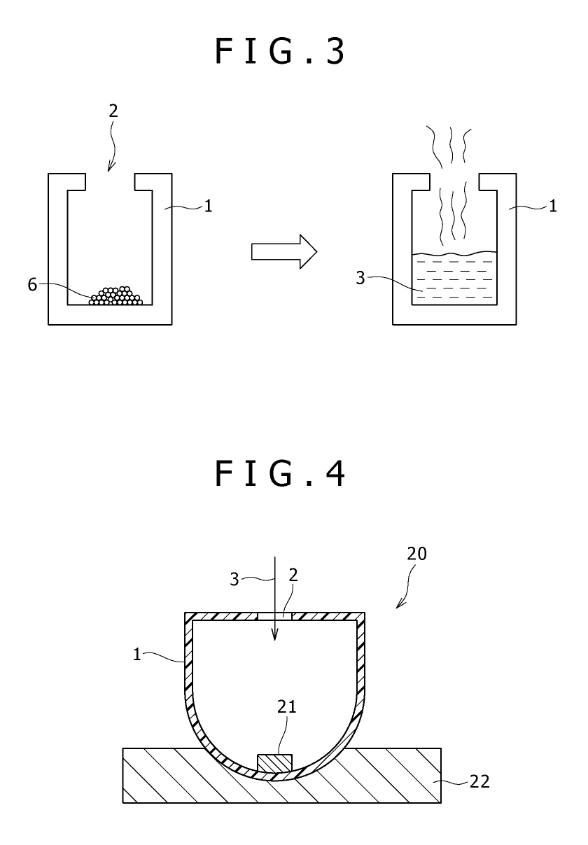

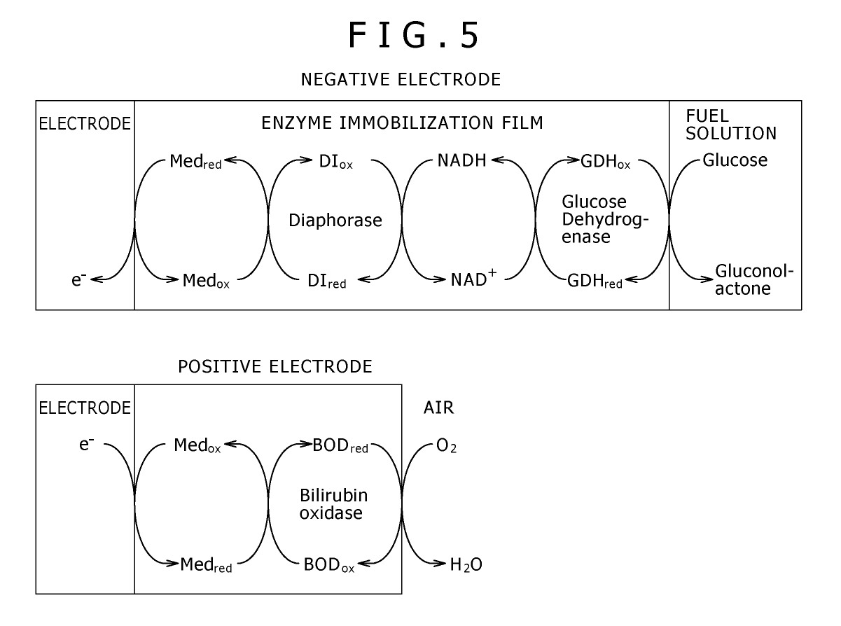

Further, the fuel solution pouring port 2 may be provided with various functions, not limited to the check valve mentioned above. FIGS. 2A and 2B each illustrate a method of sealing off the fuel solution pouring port 2 after the pouring of the fuel solution 3. FIG. 3 is a conceptual illustration of another method for preventing accidental drinking (or swallowing) of the fuel solution or the like. Specifically, as shown in FIGS. 2A and 2B, the fuel solution pouring port 2 may have a structure such that once the fuel solution 3 is poured into the fuel cell, neither pouring-in nor discharging of the fuel solution 3 is possible thereafter.

For example, in the case of the structure shown in FIG. 2A, pouring-in of the fuel solution 3 causes a sealing valve 4 to close the fuel solution pouring port 2, and, further, to be fixed in this state. In the case of the structure shown in FIG. 2B, a cap 5 is provided at the fuel solution pouring port 2, and, when the cap 5 is closed, the fuel solution pouring port 2 is broken so that it cannot be opened again. When such a structure is adopted, repeated use of the biofuel cell 10 is made impossible. However, mis-pouring of the fuel solution 3 can be prevented. In addition, an infant's accidental drinking (or swallowing) of the fuel solution or the waste solution after power generation can be prevented.

Incidentally, for prevention of accidental drinking (or swallowing) of the fuel solution or the like by an infant, other methods than the above-mentioned may also be used. For example, there is an effective method in which, as shown in FIG. 3, a material 6 capable of reacting with the fuel solution 3 to generate an unpleasant odor or taste while imposing no effect on power generation is contained in the cell section(s), or the container 1 itself is coated with a material having an unpleasant odor.

In the biofuel cell 10 according to the present embodiment, the shape of the fuel solution pouring port 2 is not particularly restricted. For example where a tank or the like filled with the fuel solution is connected to the fuel solution pouring port 2 to pour the fuel solution into the biofuel cell 10, however, it is desirable to shape the fuel solution pouring port 2 so that a discharge port of the tank or the like can be fitted therein. This makes it possible to further enhance the misuse-preventing effect. Specifically, where the fuel solution pouring port is shaped like a fruit such as apple, grape, orange and banana and the discharge port of the fuel tank or the like is so shaped as to fit into the fuel solution pouring port, a key-keyhole relationship is established, by which the risk of mis-pouring can be reduced greatly. Particularly where the above-mentioned fruit-like shape is adopted, recognition thereof by children is further facilitated, which is effective from the viewpoint of lowering the risk of misuse.

### [Fuel Solution 3]

The fuel solution 3 is a fuel component or components such as sugars, alcohols, aldehydes, lipids, proteins, etc. or a solution containing at least one of such components. Examples of the fuel component to be used in the biofuel cell 1 according to this embodiment include sugars such as glucose, fructose, sorbose, etc., alcohols such as methanol, ethanol, propanol, glycerin, polyvinyl alcohol, etc., aldehydes such as formaldehyde, acetaldehyde, etc., and organic acids such as acetic acid, formic acid, pyruvic acid, etc. Other than these materials, there can also be used fats, proteins, organic acids which are intermediate products of saccharometabolism of fats and proteins, and the like, as the fuel component.

As above-mentioned, in the biofuel cell 10 according to the present embodiment, a configuration in which the fuel solution pouring port 2 is oriented in a fixed direction is adopted, so that even a child or a visually handicapped person can easily recognize the position of the fuel solution pouring port 2. This reduces the risk of pouring the fuel solution 3 to an improper part by mistake. In addition, the fuel solution 3 for the biofuel cell 10 is a lowly dangerous solution which can even be drunk. Therefore, by making the cell in the above-mentioned configuration, it is possible, even for a child or a visually handicapped person, to pour the fuel solution 3 into the cell safely and assuredly.

Further, where the fuel solution pouring port 2 is shaped like a fruit or the like so as to be easy to understand even for children or the like or is shaped so that the fuel solution tank or the like can be fitted thereto, the risk of mis-pouring can be reduced more. Furthermore, where not only the shape of the fuel solution pouring port 2 but also the shapes of other portions such as the plus (+) terminal and the minus (−) terminal are adapted for interconnection, a mis-connection accident can be prevented from occurring.

### 2. Second Embodiment

### [General Configuration]

Now, a biofuel cell according to a second embodiment of the present invention will be described. FIG. 4 is a sectional view schematically showing the structure of the biofuel cell according to the present embodiment. In FIG. 4, the same components as those in the fuel cell 10 of the first embodiment shown in FIG. 1 above are denoted by the same reference symbols as used above, and detailed descriptions of these components will be omitted.

As shown in FIG. 4, in the biofuel cell 20 according to this embodiment, a magnet 21 is attached to a bottom portion of a container 1 so that a fuel solution pouring port 2 is oriented in a fixed direction by a magnetic force. In this case, when the biofuel cell 20 is used in the state of being placed on a base or desk formed of a metallic material, it can be used alone. When the biofuel cell 20 is used in the state of being placed on a base or desk formed of a plastic or wood or the like material to which magnetic forces cannot act, it may be necessary to use a mount 22.

### [Mount 22]

The mount 22 is a member on which to place the biofuel cell 20 at the time of pouring a fuel solution 3 into the biofuel cell 20. A mounting surface of the mount 22 is formed of a metallic material, or a magnet is attached to a mounting part of the mount 22. This ensures that the magnetic force of the magnet 21 provided at the bottom portion of the biofuel cell 20 acts so that the fuel solution pouring port 2 is oriented in a fixed direction. As a result, even a child or a visually handicapped person can pour the fuel solution 3 into the biofuel cell 20 easily and assuredly.

Further, where the mounting part of the mount 22 is formed in a recessed shape so that a lower portion of the biofuel cell 20 will be fitted into the mount 22, it is made easier to recognize the position of the fuel solution pouring port 2. This is particularly effective in the case where the container 1 is polygonal in plan view and the fuel solution pouring port 2 is provided at a side surface of the container 1.

Thus, in the biofuel cell 20 according to this embodiment, a magnetic force is utilized, so that it is possible, irrespectively of the shape of the container 1, to hold the orientation of the fuel solution pouring port 2 in a fixed direction. Consequently, recognition of the position of the fuel solution pouring port 2 is facilitated, and, therefore, the risk of pouring the fuel solution 3 to a wrong part can be reduced.

Incidentally, while the case of using the container 1 having a bottom surface composed of a curved surface is shown in FIG. 4, the present invention is not limited to this configuration. Specifically, the invention is applicable to containers with various bottom-portion shapes, such as a container having a bottom surface composed of a flat surface, a container having a bottom portion which is conical or pyramidal in shape, etc.

In addition, in the biofuel cell 20 according to the present embodiment, a magnet may be attached not only to the bottom portion of the container 1 but also to an inner side surface(s) of the container 1 so that the cells are attracted to each other by the magnetic forces of the magnets, thereby facilitating connection between a plug (+) terminal and a minus (−) terminal. This ensures that even an infant incapable of easily recognizing the plus (+) terminal and the minus (−) terminal can connect a plurality of the cells in series.

The present application contains subject matter related to that disclosed in Japanese Priority Patent Application JP 2010-109829 filed in the Japan Patent Office on May 12, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fuel cell comprising:
one or a plurality of cell sections having an electrode with an oxidoreductase present at a surface thereof; and
a container in which the cell section or sections are contained;
wherein the container is provided with a fuel solution pouring port through which to pour a fuel solution into the cell section or sections, and the fuel solution pouring port is oriented in a fixed direction at least at the time of pouring the fuel solution.

2. The fuel cell according to claim 1, wherein a bottom portion of the container has a curved surface.

3. The fuel cell according to claim 2, wherein the center of gravity of the fuel cell is set below the center of the fuel cell.

4. The fuel cell according to claim 1, wherein a magnet is attached to a bottom portion of the container, and the fuel cell is positioned by a magnetic force.

5. The fuel cell according to claim 1, further comprising a mount on which to mount the container,
wherein a magnet is attached to at least that portion of the mount on which to mount the container, and the fuel cell is positioned by a magnetic force.

6. The fuel cell according to claim 1, wherein the fuel solution pouring port is provided with a valve operative to prevent leakage of the fuel solution at least.
